(19) United States
(12) Patent Application Publication
(10) Pub. No.: US 2023/0297836 A1
(43) Pub. Date: Sep. 21, 2023

(54) ELECTRONIC DEVICE AND METHOD WITH SENSITIVITY-BASED QUANTIZED TRAINING AND OPERATION

(71) Applicant: Samsung Electronics Co., Ltd., Suwon-si (KR)

(72) Inventor: Ihor VASYLTSOV, Suwon-si (KR)

(73) Assignee: Samsung Electronics Co., Ltd., Suwon-si (KR)

(21) Appl. No.: 17/887,021

(22) Filed: Aug. 12, 2022

(30) Foreign Application Priority Data
Mar. 15, 2022 (KR) 10-2022-0032221

(51) Int. Cl. G06N 3/08

(52) U.S. Cl. CPC G06N 3/084

(57) ABSTRACT

An electronic device for performing sensitivity-based quantized training and an operating method thereof is disclosed. The electronic device includes a processor, and a memory configured to store instructions executable by the processor, wherein the processor is configured to, in response to the instructions being executed by the processor, generate, based on a determination of sensitivity of layers in a model to be trained, sensitivity results, and train the model by applying quantization to a layer of the layers with a low sensitivity of the sensitivity results lower than a predetermined threshold.

### CROSS-REFERENCE TO RELATED APPLICATIONS

This application claims the benefit under 35 USC § 119(a) of Korean Patent Application No. 10-2022-0032221, filed on Mar. 15, 2022, at the Korean Intellectual Property Office, the entire disclosure of which is incorporated herein by reference for all purposes.

### BACKGROUND

### 1. Field

The following description relates to an electronic device and method with sensitivity-based quantized training and operation.

### 2. Description of Related Art

State-of-the-art deep neural network (DNN) models may be too large and not efficient enough to be executed in limited usage environments such as mobile devices. Quantization is one of the approaches to optimizing a predetermined DNN model to be executed on predetermined hardware, and mixed-precision quantization may be one of the most promising types of quantization for optimizing a DNN model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes a processor, and a memory configured to store instructions executable by the processor, wherein the processor is configured to, in response to the instructions being executed by the processor, generate, based on a determination of sensitivity of layers in a model to be trained, sensitivity results, and train the model by applying quantization to a layer of the layers with a low sensitivity of the sensitivity results lower than a predetermined threshold.

The processor may be further configured to process the layer with the low sensitivity lower than the predetermined threshold with a first precision by quantizing the layer, and process a layer with a high sensitivity of the sensitivity results higher than or equal to the predetermined threshold with a second precision, higher than the first precision, without quantization.

The processor may be further configured to perform, on the model, distributed training including operations of performing forward propagation moving from a first layer to a last layer of the model, performing backward propagation moving from the last layer to the first layer of the model, determining a mean value of gradients calculated in each of a plurality of nodes used for the distributed training of the model, and updating a weight of the model based on the mean value.

The processor may be further configured to periodically determine training sensitivity of the layers for each training of the model, or for each epoch or each of one or more iterations performed during the training of the model.

The processor may be further configured to generate, based on a determination of channel-wise sensitivity of a tensor used for the model, channel-wise sensitivity results; process a channel with a low channel-wise sensitivity of the channel-wise sensitivity results lower than a second predetermined threshold with a first precision by applying quantization to the channel; and process a channel with a high channel-wise sensitivity of the channel-wise sensitivity results higher than or equal to the second predetermined threshold with a second precision, higher than the first precision, without quantization.

The processor may be further configured to classify the sensitivity results of the layers into a plurality of levels, and train the model by applying quantization to each of the layers with a precision at a level corresponding to each of the plurality of levels.

The processor may be further configured to train the model by applying quantization to the layer with the low sensitivity lower than the predetermined threshold in any one or any combination of the operations the distributed training includes.

The processor may be further configured to compress data used in any one or any combination of the operations.

The processor may be further configured to train the model by scaling a gradient calculated in training the model.

The processor may be further configured to determine the mean value using “k” largest gradients of the gradients calculated in each of the plurality of nodes, or by applying a genetic algorithm to the gradients, where k is an integer.

The model to be trained may be pretrained with a precision without quantization.

In another general aspect, an operating method includes generating, based on a determination of sensitivity of layers in a model to be trained, sensitivity results, and training the model by applying quantization to a layer of the layers with a low sensitivity of the sensitivity results lower than a predetermined threshold.

The training of the model may include processing the layer with the low sensitivity lower than the predetermined threshold with a first precision by quantizing the layer, and processing a layer with a high sensitivity of the sensitivity results higher than or equal to the predetermined threshold with a second precision, higher than the first precision, without quantization.

The training of the model may include performing, on the model, distributed training comprising operations of performing forward propagation moving from a first layer to a last layer of the model, performing backward propagation moving from the last layer to the first layer of the model, determining a mean value of gradients calculated in each of a plurality of nodes used for the distributed training of the model, and updating a weight of the model based on the mean value.

The determining of the sensitivity may include periodically determining training sensitivity of the layers for each training of the model, or for each epoch or each of one or more iterations performed during the training of the model.

The determining of the sensitivity may include generating, based on a determination of channel-wise sensitivity of a tensor used for the model, channel-wise sensitivity results, and the training of the model comprises training the model by applying quantization to a channel with a low channel-wise sensitivity of the channel-wise sensitivity results lower than a second predetermined threshold.

The determining of the sensitivity may include classifying the sensitivity results of the layers into a plurality of levels, and the training of the model including training the model by applying quantization to each of the layers with a precision at a level corresponding to each of the plurality of levels.

The training of the model may include training the model by applying quantization to the layer with the low sensitivity lower than the predetermined threshold in any one or any combination of the operations the distributed training includes.

The model to be trained may include pretrained with a precision without quantization.

Other features and aspects will be apparent from the following detailed description, the drawings, and the claims.

### BRIEF DESCRIPTION OF THE DRAWINGS

FIG. 1 illustrates an example of a neural network according to one or more embodiments.

FIG. 2 illustrates an example of distributed parallel model training.

FIG. 3 illustrates an example of model training according to a layer sensitivity analysis.

FIG. 4 illustrates an example of model training according to a channel-wise sensitivity analysis.

FIG. 5 illustrates an example of model training according to layer sensitivity lists.

FIG. 6 illustrates an example of model training according to partial quantization and additional compression.

FIG. 7 illustrates an example of model training according to a gradient loss.

FIG. 8 illustrates an example of calculating a mean value of gradients.

FIG. 9 illustrates an example of an operating method of an electronic device.

FIG. 10 illustrates an example of an electronic device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

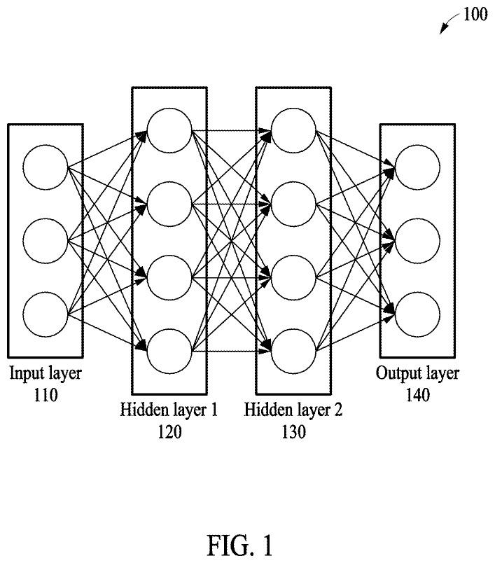

FIG. 1 illustrates an example of a neural network.

Referring to FIG. 1, a neural network 100 may include a plurality of layers. For example, the neural network 100 may include an input layer 110, a plurality of hidden layers 120 and 130, and an output layer 140. The neural network 100 may be used to perform a data inference. The data inference may include, for example, pattern recognition (e.g., object recognition, face identification, etc.), sequence recognition (e.g., speech, gesture, and handwritten texture recognition, machine translation, machine interpretation, etc.), control (e.g., vehicle control, processor control, etc.), recommendation services, decision making, medical examination or diagnosis, financial applications, data mining, and the like. However, the examples of the data inference are not limited thereto. Herein, the neural network 100 may also be referred to as a model for the convenience of description.

Each of the layers may include a plurality of nodes, each referred to as an artificial neuron. Each node is a calculation unit having one or more inputs and outputs, and the nodes may be connected to each other. Herein, it is noted that use of the term ‘may’ with respect to an example or embodiment, e.g., as to what an example or embodiment may include or implement, means that at least one example or embodiment exists where such a feature is included or implemented while all examples and embodiments are not limited thereto.

The input layer 110 may include one or more nodes to which data is input directly, not through a connection to another node. The output layer 140 may include one or more nodes not having an output node in a connection to another node. The hidden layers 120 and 130 may be the remaining layers of the neural network 100 from which the input layer 110 and the output layer 140 are excluded, and include nodes corresponding to an input node or output node in a relationship with another node. The neural network 100 is illustrated merely as an example in FIG. 1 for the convenience of description, and thus the scope of examples is not limited by the illustrated structure of the neural network 100. The neural network 100 used in the example may be provided in various structures. The number of hidden layers in the neural network 100, the number of nodes in each layer, and/or a connection between nodes may vary depending on an example. The neural network 100, including the plurality of hidden layers, may be referred to as a deep neural network (DNN).

A weight may be set for a connection between nodes. For example, a weight may be set for a connection between a node in the input layer 110 and another node in the hidden layer 120. The weight may be adjusted or changed. The weight amplifies, reduces, or maintains a relevant data value, thereby determining the degree of influence of the data value on a final result. The weight may correspond to a parameter of the neural network 100.

To each node included in one layer, weighted values of nodes included in a previous layer may be input. A weighted value may be an obtained value (e.g., an activation) of a node included in the previous layer multiplied by a weight. A process of inputting weighted data from a predetermined layer to a next layer may be referred to as propagation.

In general, weight and activation may be represented in a 32-bit flowing point (FP32) precision representing data by 32 bits, or in a 16-bit brain floating-point (BFLOAT16) precision representing data by 16 bits. Although the accuracy of inference may be improved through the precisions, a lot of time and resources (e.g., power consumption, memory, etc.) are required for performing inference using the neural network 100 or training the neural network 100, and the neural network 100 may be difficult to operate in a usage environment with limited resources (e.g., a mobile device, etc.).

As the weight and activation are represented with relatively few bits through model quantization, the inference by the neural network 100 may be compressed and accelerated. Furthermore, since the neural network 100 may be executed using a low-precision accelerator (e.g., an accelerator with an INT2, INT4, or INT8 precision), it is possible to reduce latency and power consumption effectively during the inference. However, if the same precision (the number of bits) is applied to all layers included in the neural network 100, inference accuracy may decrease due to quantization.

In mixed-precision quantization, the plurality of layers included in the neural network 100 may have different precisions. Applying a high precision to a sensitive layer of the plurality of layers and applying a low precision to a robust layer through mixed-precision quantization may minimize the performance degradation caused by quantization, but may increase the complexity of searching for an optimal mixed-precision quantization. For example, when the neural network 100 includes 50 layers, and the neural network 100 may use three precisions (e.g., INT4, INT8, and INT16), a total search space may be of a size corresponding to 350, which is considerable. In addition, although it is possible to reduce the computational complexity of model training by using a low precision, a significant decrease in accuracy may occur, which may slow model convergence, and an additional iteration may be required for model accuracy.

According to an example described herein, an operation of training a model by applying sensitivity analysis to a plurality of layers included in the model and applying quantization to at least some layers according to sensitivity may be performed. As such, it may be possible to reduce training time, effectively reduce the bandwidth of data communication and power consumption, and automatically generate a more efficient solution for quantized inference by quantizing some layers with low precisions to train a model. Examples will be described in detail hereinafter.

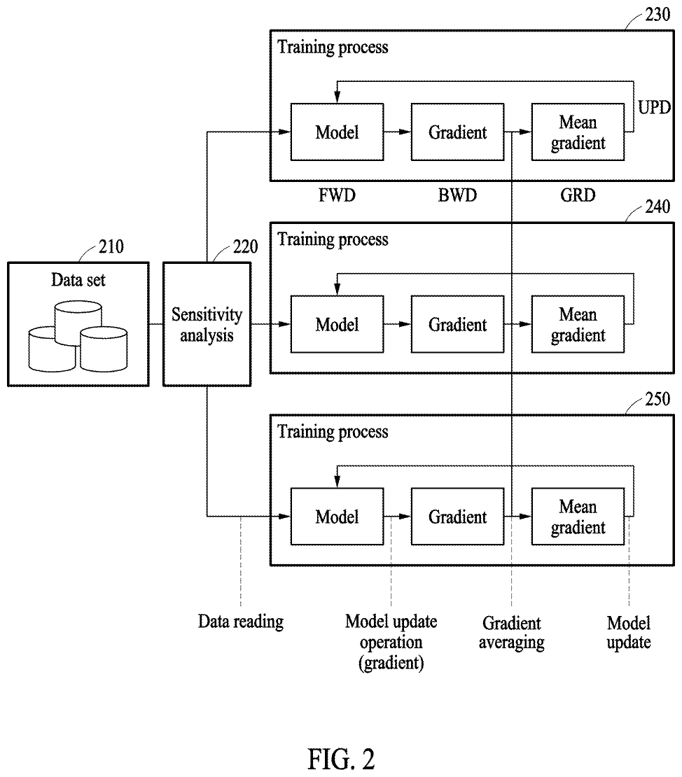

FIG. 2 illustrates an example of distributed parallel model training.

Referring to FIG. 2, model training may be performed in a plurality of nodes 230, 240, and 250. For clarity and convenience of description, model training may be described herein as model training in a data parallelism scenario.

Distributed parallel model training may be performed in the plurality of nodes 230, 240, and 250. Each plurality of nodes 230, 240, and 250 may perform model training based on training data transmitted from a data set 210. Forward FWD, backward BWD, gradient GRD, and update UPD operations illustrated in FIG. 2 may be repeatedly performed.

In an FWD operation, forward propagation may be performed in which an activation is sequentially calculated from a first layer to a last layer of a model. In a BWD operation, a loss may be propagated in a backward direction from the last layer to the first layer of the model, and a gradient may be calculated. Here, the loss may indicate a difference between an inference result output from an output layer of the model in an FWD operation and a label included in the training data. In a GRD operation, a mean value of gradients calculated in each of the plurality of nodes 230, 240, and 250 may be determined. The gradients calculated in each of the plurality of nodes 230, 240, and 250 may differ due to differences in training data used for training, and the mean value of the gradients may be calculated in a GRD operation. Depending on an example, BWD and GRD operations may be simultaneously performed to increase an overall process speed, but this case is not considered here for the convenience of description. However, an example is not limited thereto, and the description provided here may apply, without limitation, even when BWD and GRD operations are simultaneously performed. In a UPD operation, the weight of the model may be updated according to the mean value of the gradients. An updated weight may be transmitted to each of the plurality of nodes 230, 240, and 250 and reflected in the next training (e.g., an iteration, an epoch, etc.).

The above-described FWD, BWD, GRD, and UPD operations may be repeated until the model converges. If a high precision (e.g., FP32, and 16-bit floating-point (FP16)) is used for model calculation and data communication among nodes, end-to-end training may slow down, and more power may be consumed. On the other hand, if a weight, an activation, and a gradient with a low precision are uniformly used to speed up the end-to-end training and reduce power consumption, model convergence may slow down because of significant accuracy degradation, and thus, more iterations may be required to increase model accuracy to a certain level. Therefore, selectively applying a low precision to at least some layers that meet a predetermined condition may speed up the end-to-end training, reduce power consumption, and minimize accuracy degradation. For this purpose, a sensitivity analysis 220 may be performed.

The sensitivity analysis 220 may be performed for layers included in the model. In response to a determination of whether sensitivity for each of the layers is lower than a predetermined threshold, for a layer having sensitivity lower than the threshold, weight and/or input data (e.g., an input tensor) may be quantized to be processed with low precision (e.g., INT2, INT4, INT8, etc.). For example, the sensitivity analysis 220 and quantization may be expressed as Equation 1.

$$if {s}_{i} < thr then : \begin{matrix}〈 {w}_{i} 〉 = quantize ( 〈 {w}_{i} 〉 ) \\ 〈 {x}_{i} 〉 = quantize ( 〈 {x}_{i} 〉 )\end{matrix} with \begin{matrix}quantize \text{(*} ) = int8 \text{(*} ) \\ quantize \text{(*} ) = int4 \text{(*} )\end{matrix}$$

In Equation 1, Sᵢ may denote the sensitivity of an ith layer, thr may denote a predetermined threshold, wᵢ may denote a weight vector of the ith layer, and xᵢ may denote a tensor input to the ith layer.

The sensitivity analysis 220 expressed as Sᵢ<thr in Equation 1 may be performed periodically. For example, the sensitivity analysis 220 may be performed periodically for each training of the model, or for each epoch or each of one or more iterations performed during the training of the model.

By selectively applying quantization to a less sensitive (or more robust) layer based on the sensitivity analysis 220, it may be possible to reduce the accuracy degradation of the model due to the quantization to minimize additional iterations for securing model accuracy, speed up the end-to-end training, and effectively reduce power consumption. It also may be possible to reduce training time, decrease data communication bandwidth among layers and/or nodes, and automatically generate a more efficient solution for quantized inference.

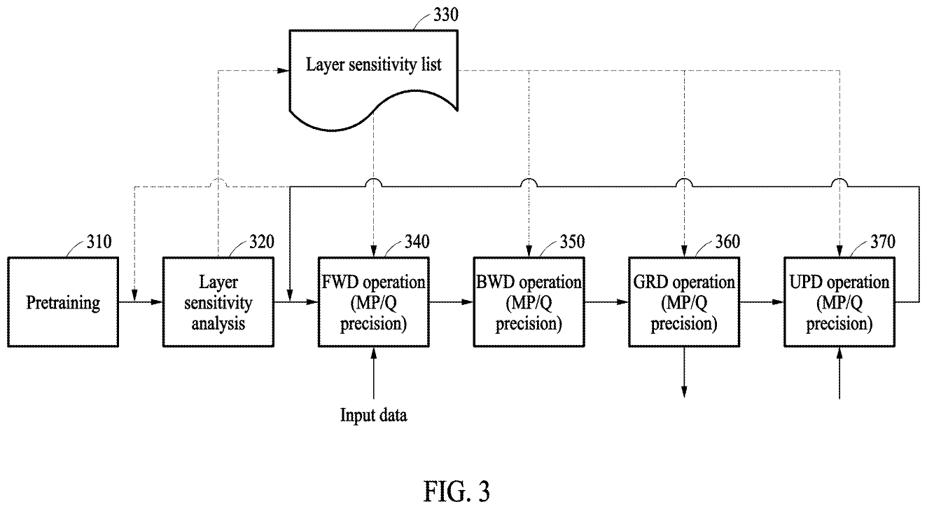

FIG. 3 illustrates an example of model training according to a layer sensitivity analysis.

FIG. 3 illustrates an example of a sensitivity-based quantization training operation with mixed precision.

In operation 310, a model may be pretrained. For example, the model may be partially trained with a high precision (e.g., FP32, FP16, etc.) before being trained by the distributed parallel model training described here.

For example, a model trained for a short sentence (e.g., a sentence of less than or equal to 128 words) based on FP32 and corresponding to an MLPerf scenario, which is a state before additional training for a long sentence (e.g., a sentence of more than 128 words and less than or equal to 512 words) is performed, may be a model pretrained in operation 310.

In addition, a model partially pretrained with an FP32 and/or FP16 precision during a warm-up period may be a model pretrained in operation 310.

In operation 320, the sensitivity of layers included in the model may be analyzed. Since operation 320 is periodically performed for each training, or for each epoch or each of one or more iterations performed in the training of the model, operation overhead according to a layer sensitivity analysis may be small and ignored. A layer sensitivity list 330 may be generated through layer sensitivity analysis. The layer sensitivity list 330 may include sensitivity information on a plurality of layers included in the model, and based on the layer sensitivity list 330, one or more layers having sensitivity lower than a predetermined threshold may be quantized and processed with a low precision in FWD operation 340, BWD operation 350, GRD operation 360, and UPD operation 370.

As described above, training performance may be more improved when a layer having low sensitivity is selectively quantized and processed with low precision and when a layer having high sensitivity is processed with high precision without quantization than when all layers are quantized to be processed with low precision, and sometimes, as a result of better normalization, the performance may be more improved than when all the layers are always processed with high precision. In summary, through mixed precision-based training with selective quantization, reasonable model performance may be expected, while the overall training time of a model may be reduced, the bandwidth of data communication performed in model processing may be reduced, calculation of data quantized by utilizing hardware functions may be efficiently accelerated, and a more efficient solution for quantized inference may be automatically obtained.

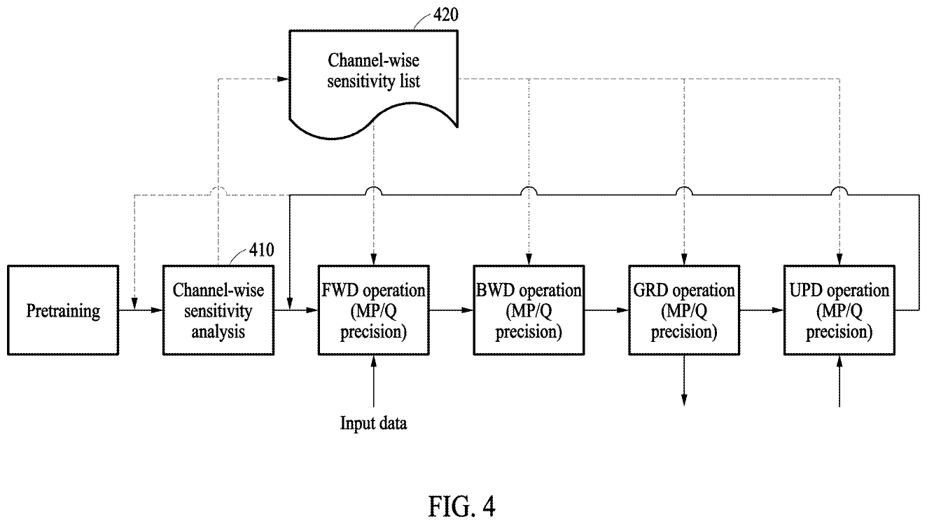

FIG. 4 illustrates an example of model training according to a channel-wise sensitivity analysis.

Referring to FIG. 4, an example of selectively applying quantization according to channel-wise sensitivity of a tensor used for a model to train the model. While FIG. 3 illustrates an example of analyzing sensitivity for each layer, FIG. 4 illustrates an example of analyzing sensitivity for each channel which is a more specified unit, and an example of applying quantization to a channel with sensitivity lower than a second predetermined threshold to train a model. A channel having sensitivity higher than or equal to the second threshold may be processed with high precision without quantization. In operation 410 illustrated in FIG. 4, channel-wise sensitivity may be analyzed, and as a result, a channel-wise sensitivity list 420 may be generated. The channel-wise sensitivity list 420 may include channel-wise sensitivity information, and based on the information, quantization may be selectively applied according to channel-wise sensitivity in FWD through UPD operations. The descriptions with reference to FIG. 3 may apply to the remaining operations. Thus, a more detailed description is not included here.

As such, by selectively applying quantization to a channel according to the channel-wise sensitivity to train a model, it may be possible to further increase the specificity of model approximation, and accordingly, accuracy degradation due to quantization may be further reduced. In addition, it may be possible to effectively speed up end-to-end training.

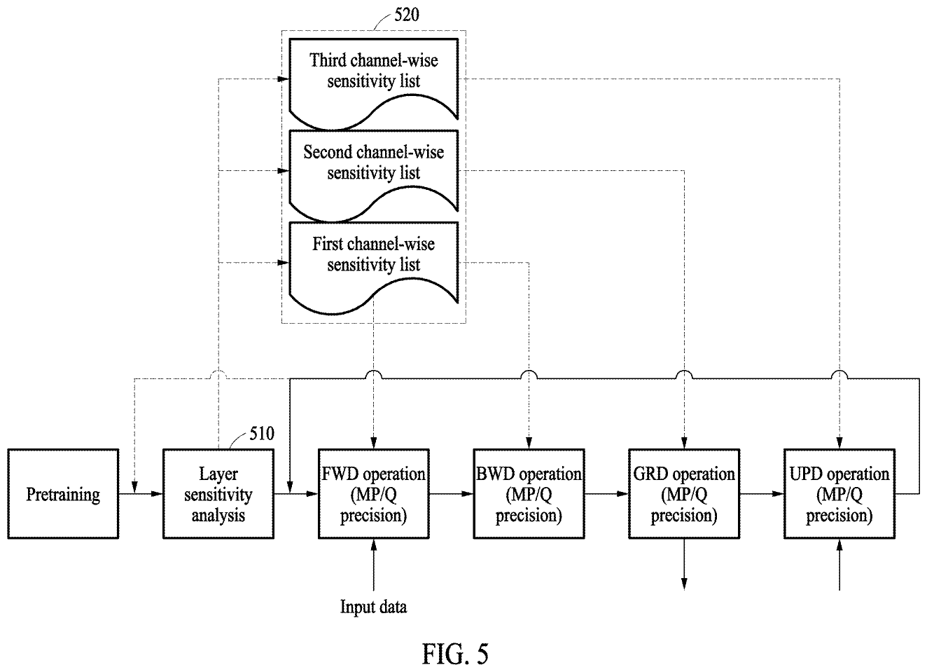

FIG. 5 illustrates an example of model training according to layer sensitivity lists.

FIG. 5 also illustrates an example of training a model based on a plurality of layer sensitivity lists 520 generated by a layer sensitivity analysis is illustrated. Although an example of selectively applying quantization according to the layer sensitivity list 330 is illustrated in FIG. 3, examples are not limited thereto, and a plurality of layer sensitivity lists may be provided depending on an example.

In response to a layer sensitivity analysis being performed in operation 510, the sensitivity of layers included in a model may be classified into a plurality of levels, and accordingly, the plurality of layer sensitivity lists 520 may be generated. For example, a first layer sensitivity list may include information on a layer having sensitivity lower than a first threshold, a second layer sensitivity list may include information on a layer having sensitivity lower than a second threshold, and a third layer sensitivity list may include information on a layer having sensitivity lower than a third threshold. Thresholds may increase in an order of the first threshold, the second threshold, and the third threshold, but examples are not limited thereto. Sensitivity may be analyzed in a much more granular way through the plurality of layer sensitivity lists 520 and utilized in model training. The plurality of layer sensitivity lists 520 may be applied to any one or any combination of FWD operation, BWD operation, GRD operation, and UPD operation, and a different layer sensitivity list may be applied to each operation.

Accordingly, the specificity of model approximation may be further improved, and as a result, accuracy degradation due to quantization may be effectively suppressed, and the speed of end-to-end distributed training may be further increased.

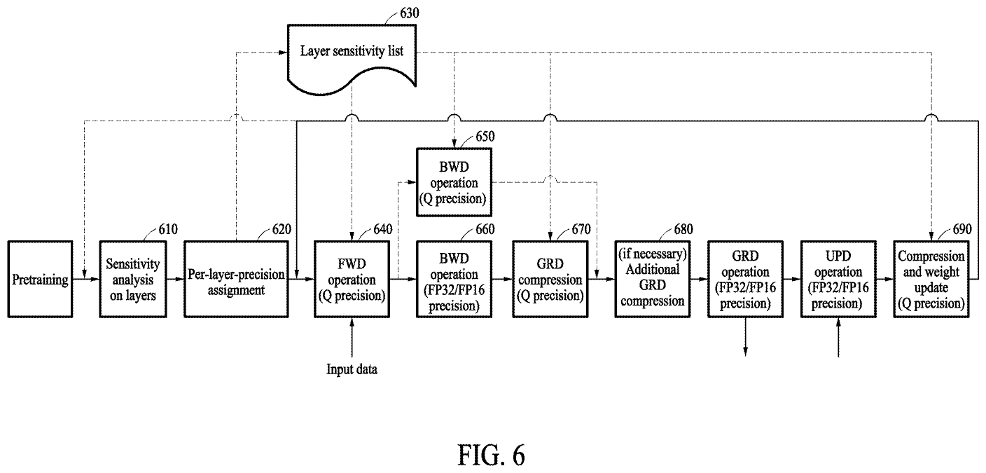

FIG. 6 illustrates an example of model training according to partial quantization and additional compression.

Referring to FIG. 6, quantization may be applied to some of the four operations included in distributed parallel model training.

In operation 610, the sensitivity of layers may be analyzed. In operation 620, per-layer-precisions may be assigned. For example, a high precision (e.g., FP32, FP16, etc.) may be assigned to a layer having high sensitivity, and low precision (e.g., INT2, INT4, INT8, etc.) may be assigned to a layer having low sensitivity. Through this process, a layer sensitivity list 630 may be generated.

As illustrated in FIG. 6, quantization may be applied to FWD operation 640, so a layer with low sensitivity may be processed with low precision. A BWD operation, depending on an example, may be separated into operation 650, to which quantization is applied, and operation 660, to which quantization is not applied, and one of which may be performed. In response to operation 660, to which quantization is not applied being performed as a BWD operation, compression 670 may be performed in a GRD operation. In this case, quantization may be applied to the compression, so that a layer having a low sensitivity may be processed with low precision. Further, additional GRD compression 680 may be performed if necessary. The quantization may also be applied to this operation, so a layer with a low sensitivity may be processed with low precision. Thereafter, a GRD or UPD operation may be processed with high precision without quantization, and a compression and weight update 690 to which quantization is applied may be additionally performed. However, the example illustrated in FIG. 6 is provided only for the convenience of description, and thus, an operation to which quantization may be applied is not limited to the above-described example.

As described above, by selectively applying quantization to some operations included in the distributed parallel model training, it may be possible to flexibly control the balance between design complexity, a speed of performance improvement, and accuracy degradation in model training.

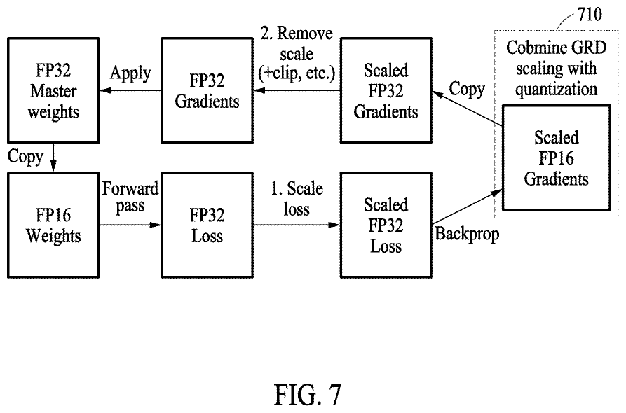

FIG. 7 illustrates an example of model training according to a gradient loss.

Referring to FIG. 7, gradient/loss scaling, a known scheme of reducing accuracy degradation applied in mixed precision model training, may be applied to distributed parallel model training described herein. Of the gradient/loss scaling schemes illustrated in FIG. 7, gradient scaling 710 may be applied to the distributed parallel model training, during which quantization may also be applied. Accordingly, in GRD operation, it may be possible to effectively reduce a data size to be moved to another node and further speed up a training process.

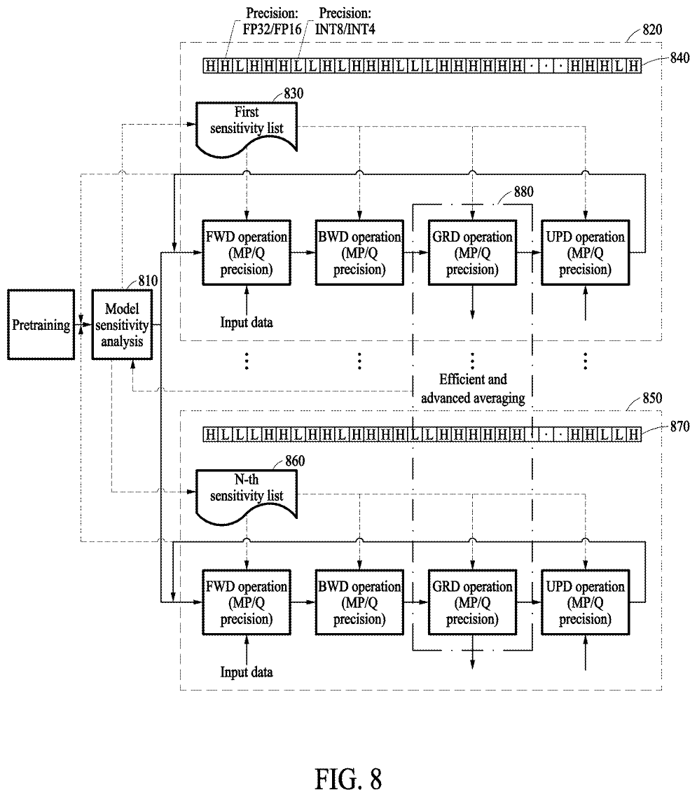

FIG. 8 illustrates an example of calculating a mean value of gradients.

Referring to FIG. 8, if different training goals (e.g., speed, power, and bandwidth) are considered simultaneously, optimization of a quantization goal-based model may be multi-variant. Per-layer-precisions may also vary. In this case, efficient and advanced averaging schemes may be applied to various per-layer-precisions that are used.

A plurality of nodes 820 and 850 used for distributed parallel model training may have the same base model but have different per-layer-precisions based on different sensitivity lists 830 and 860 according to a model sensitivity analysis 810. For example, a precision 840 applied to each of the layers according to a first sensitivity list 830 applied to a first node 820 and a precision 870 applied to each of the layers according to an nth sensitivity list 860 applied to an nth node 850 may be different.

For efficient and advanced averaging, a TopK and a genetic algorithm may be used in GRD operation 880. For example, a mean value of gradients may be calculated by using “k” largest gradients of gradients calculated in each of the plurality of nodes 820 and 850. In addition, GRD operation 880 may provide feedback to sensitivity analysis to help find a more optimal quantization scheme. Particularly, for a large DNN model, it may be possible to effectively speed up model convergence by simultaneously using different layer-per-layer-precision configurations.

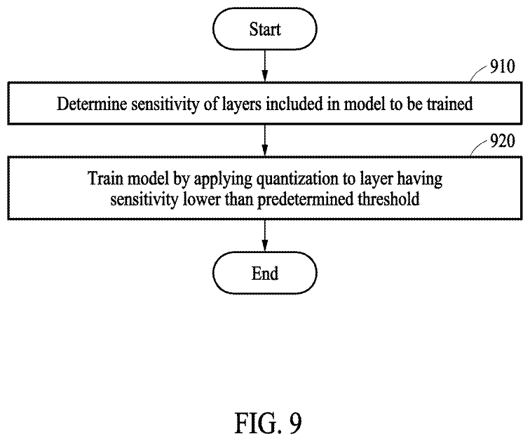

FIG. 9 illustrates an example of an operating method of an electronic device.

In the following examples, operations may be performed sequentially, but not necessarily sequentially. For example, the order of the operations may change, and the operations may be performed in parallel. In addition, operations 910 to 920 may be performed by at least one component (e.g., a processor, an accelerator, etc.) of the electronic device.

In operation 910, the electronic device may determine the sensitivity of layers included in a model to be trained. The electronic device may periodically determine the sensitivity of the layers for each training of the model, or for each epoch or each of one or more iterations performed during the training of the model. The model to be trained may be pretrained with precision without quantization.

In operation 920, the electronic device may train a model by applying quantization to a layer with sensitivity lower than a predetermined threshold.

The electronic device may process the layer having a sensitivity lower than the threshold with a first precision by quantizing the layer, and may process a layer having sensitivity higher than the threshold with a second precision higher than the first precision without quantization.

The electronic device may perform, on the model, distributed training, including operations of performing forward propagation which is a process of moving from the first layer to the last layer of the model, performing backward propagation, which is a process of moving from the last layer to the first layer of the model, determining a mean value of gradients calculated in each of a plurality of nodes used for the distributed training of the model, and updating a weight of the model according to the mean value.

In addition, the electronic device may determine the channel-wise sensitivity of a tensor used in the model and train the model by applying quantization to a channel with sensitivity lower than a second predetermined threshold.

Alternatively, the electronic device may classify the sensitivity of the layers included in the model into a plurality of levels and train the model by applying quantization to each of the layers with precision at a level corresponding to each of the plurality of levels.

Further, the electronic device may train the model by applying quantization to the layer with sensitivity lower than the predetermined threshold in any one or any combination of the operations included in the distributed training.

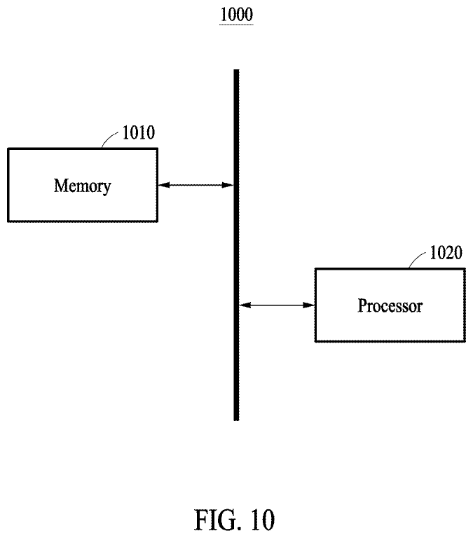

FIG. 10 illustrates an example of an electronic device.

Referring to FIG. 10, an electronic device 1000 may include a memory 1010 and a processor 1020. The memory 1010 and the processor 1020 may communicate with each other through a bus, a peripheral component interconnect express (PCIe), a network on a chip (NoC), or the like.

The memory 1010 may include computer-readable instructions. In response to the execution of the instructions stored in the memory 1010 by the processor 1020, the processor 1020 may perform the operations described above. The memory 1010 may be a volatile memory or a non-volatile memory.

The processor 1020 may be a device that executes the instructions or programs or that controls the electronic device 1000, and includes, for example, a host processor and/or an accelerator included in the electronic device 1000. The host processor may be a device that controls operations of components included in the electronic device 1000 and includes, for example, a central processing unit (CPU). The accelerator may be an artificial intelligence (AI) accelerator configured to infer input data by executing a neural network in accordance with an instruction from the host processor, and include, for example, a neural processing unit (NPU), a graphics processing unit (GPU), a tensor processing unit (TPU), a digital signal processor (DSP), and the like.

The processor 1020 may determine the sensitivity of layers included in a model to be trained and train the model by applying quantization to a layer having a sensitivity lower than a predetermined threshold.

The electronic device 1000 may be implemented by a server or a specially designed computing device. However, examples are not limited thereto. In addition, the electronic device 1000 may be implemented, without limitation, by various computing devices such as a smart phone, a tablet, a laptop and a personal computer, various wearable devices such as a smart watch, smart glasses and smart clothes, various home appliances such as a smart speaker, a smart TV and a smart refrigerator, a smart car, a smart kiosk, an Internet of things (IoT) device, a walking assist device (WAD), a drone, and a robot.

In addition, the electronic device 1000 may process the operations described above.

As a non-exhaustive example only, an electronic device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device configured to perform wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

The electronic device in FIGS. 1-10 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An electronic device comprising:
a processor; and
a memory configured to store instructions executable by the processor,
wherein the processor is configured to, in response to the instructions being executed by the processor:
generate, based on a determination of sensitivity of layers in a model to be trained, sensitivity results; and
train the model by applying quantization to a layer of the layers with a low sensitivity of the sensitivity results lower than a predetermined threshold.

2. The electronic device of claim 1, wherein the processor is further configured to:
process the layer with the low sensitivity lower than the predetermined threshold with a first precision by quantizing the layer; and
process a layer with a high sensitivity of the sensitivity results higher than or equal to the predetermined threshold with a second precision, higher than the first precision, without quantization.

3. The electronic device of claim 1, wherein the processor is further configured to perform, on the model, distributed training comprising operations of:
performing forward propagation moving from a first layer to a last layer of the model;
performing backward propagation moving from the last layer to the first layer of the model;
determining a mean value of gradients calculated in each of a plurality of nodes used for the distributed training of the model; and
updating a weight of the model based on the mean value.

4. The electronic device of claim 1, wherein the processor is further configured to periodically determine training sensitivity of the layers for each training of the model, or for each epoch or each of one or more iterations performed during the training of the model.

5. The electronic device of claim 1, wherein the processor is further configured to:
generate, based on a determination of channel-wise sensitivity of a tensor used for the model, channel-wise sensitivity results;
process a channel with a low channel-wise sensitivity of the channel-wise sensitivity results lower than a second predetermined threshold with a first precision by applying quantization to the channel; and
process a channel with a high channel-wise sensitivity of the channel-wise sensitivity results higher than or equal to the second predetermined threshold with a second precision, higher than the first precision, without quantization.

6. The electronic device of claim 1, wherein the processor is further configured to:
classify the sensitivity results of the layers into a plurality of levels; and
train the model by applying quantization to each of the layers with a precision at a level corresponding to each of the plurality of levels.

7. The electronic device of claim 3, wherein the processor is further configured to train the model by applying quantization to the layer with the low sensitivity lower than the predetermined threshold in any one or any combination of the operations the distributed training comprises.

8. The electronic device of claim 7, wherein the processor is further configured to compress data used in any one or any combination of the operations.

9. The electronic device of claim 1, wherein the processor is further configured to train the model by scaling a gradient calculated in training the model.

10. The electronic device of claim 3, wherein the processor is further configured to determine the mean value using “k” largest gradients of the gradients calculated in each of the plurality of nodes, or by applying a genetic algorithm to the gradients, where k is an integer.

11. The electronic device of claim 1, wherein the model to be trained is pretrained with a precision without quantization.

12. An operating method, comprising:
generating, based on a determination of sensitivity of layers in a model to be trained, sensitivity results; and
training the model by applying quantization to a layer of the layers with a low sensitivity of the sensitivity results lower than a predetermined threshold.

13. The operating method of claim 12, wherein the training of the model comprises:
processing the layer with the low sensitivity lower than the predetermined threshold with a first precision by quantizing the layer; and
processing a layer with a high sensitivity of the sensitivity results higher than or equal to the predetermined threshold with a second precision, higher than the first precision, without quantization.

14. The operating method of claim 12, wherein the training of the model comprises performing, on the model, distributed training comprising operations of:
performing forward propagation moving from a first layer to a last layer of the model;
performing backward propagation moving from the last layer to the first layer of the model;
determining a mean value of gradients calculated in each of a plurality of nodes used for the distributed training of the model; and
updating a weight of the model based on the mean value.

15. The operating method of claim 12, wherein the determining of the sensitivity comprises periodically determining training sensitivity of the layers for each training of the model, or for each epoch or each of one or more iterations performed during the training of the model.

16. The operating method of claim 12, wherein
the determining of the sensitivity comprises generating, based on a determination of channel-wise sensitivity of a tensor used for the model, channel-wise sensitivity results, and
the training of the model comprises training the model by applying quantization to a channel with a low channel-wise sensitivity of the channel-wise sensitivity results lower than a second predetermined threshold.

17. The operating method of claim 12, wherein
the determining of the sensitivity comprises classifying the sensitivity results of the layers into a plurality of levels, and
the training of the model comprises training the model by applying quantization to each of the layers with a precision at a level corresponding to each of the plurality of levels.

18. The operating method of claim 14, wherein the training of the model comprises training the model by applying quantization to the layer with the low sensitivity lower than the predetermined threshold in any one or any combination of the operations the distributed training comprises.

19. The operating method of claim 12, wherein the model to be trained is pretrained with a precision without quantization.

20. A non-transitory computer-readable storage medium storing instructions that, when executed by a processor, cause the processor to perform the operating method of claim 12.
